(19) United States
(12) Patent Application Publication
(10) Pub. No.: US 2017/0178157 A1
(43) Pub. Date: Jun. 22, 2017

(54) TARGETING CONTENT TO USERS IN GROUPS

(71) Applicant: Ranjith Jayaram, San Jose, CA (US)

(72) Inventor: Ranjith Jayaram, San Jose, CA (US)

(73) Assignee: GOOGLE INC., Mountain View, CA (US)

(21) Appl. No.: 13/414,656

(22) Filed: Mar. 7, 2012

(51) Int. Cl. G06Q 30/02; G06F 15/16

(52) U.S. Cl. CPC G06Q 30/0202; G06Q 30/0244

(57) ABSTRACT

Methods, systems, and apparatus, including computer programs encoded on a computer-readable storage medium, and including a method for providing advertisements. The method comprises determining at least in part based on analysis of user interaction data of a plurality of users in a user network, an inferred group of users that interact together, including two or more users from the users in the user network. The method further comprises receiving a request to present an advertisement to each of two or more users of a group of users that interact together, and based at least in part on the received request, providing for display, to each of two or more of the users in the inferred group of users that interact together, the requested advertisement.

### BACKGROUND

This specification relates to information presentation. More specifically, this specification relates to presenting content to users.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Content item slots can be allocated to content sponsors as part of a reservation system, or in an auction. For example, content sponsors can provide bids specifying amounts that the sponsors are respectively willing to pay for presentation of their content. In turn, an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for providing advertisements. The method comprises determining, using one or more computing devices, at least in part based on analysis of user interaction data of a plurality of users in a user network, an inferred group of users that interact together, where the inferred group of users that interact together includes two or more users from the plurality of users in the user network. The method further comprises receiving, using the one or more computing devices, a request to present an advertisement to each of two or more users of a group of users that interact together. The method further comprises, based at least in part on the received request to present an advertisement to each of two or more users of a group of users that interact together and the determined inferred group of users that interact together, providing for display, to each of two or more of the users in the inferred group of users that interact together, the requested advertisement.

These and other implementations can each optionally include one or more of the following features. The method can further comprise analyzing, using the one or more computing devices, the user interaction data for the plurality users in the user network. The user network can be a social network and the group of users that interact together can be a user-defined social circle. Determining the inferred group of users can comprise determining users that have communicated at least a pre-determined number of times. Determining the inferred group of users can comprise determining users that are members of the same demographic and including the users in the inferred group. Using the inferred group to either target content to users in the inferred group or promote content associated with a campaign targeted at the inferred group can comprise boosting scores associated with advertisements that are targeted to inferred groups. Communications between group members in the inferred group can relate to a single subject matter. Determining an inferred group can further comprise identifying, for each user in a plurality of users, one or more social circles, and determining an intersection of the one or more social circles for each user with all other users in the plurality of users to determine users to be included in the inferred group. Determining an inferred group can further comprise determining a sub-group of a social circle for a user and identifying users of the sub-group as belonging to the inferred group. Determining a sub-group of users can further comprise identifying the users of the sub-group based on a number of communications between the users. Determining a sub-group of users can further comprise identifying the users of the sub-group based on subject matter of communications between the users. Determining an inferred group can further comprise determining a sub-group of users within a social graph, where the social graph contains an edge between two users if the two users have mutually agreed to be connected with each other. Determining a sub-group of users can further comprise identifying the users of the sub-group based on a number of communications between the users. Determining a sub-group of users can further comprise identifying the users of the sub-group based on a subject matter of communications between the users. Targeting can further comprise enabling a content sponsor to target the inferred group. Targeting can comprise enabling one or more content sponsors to discover the inferred group and enabling the one or more content sponsors to target content to the inferred group. Targeting can comprise targeting content to users of the inferred group upon receipt of a request for content from one of the users. Targeting can content further comprise targeting content to one or more types of inferred groups including bidding on one or more inferred groups of a given type. The one or more types of inferred groups can be inferred groups that are specified by a content sponsor for a campaign.

In general, another innovative aspect of the subject matter described in this specification can be implemented in methods that include a method for delivering content to users. The method comprises receiving an indication from a content sponsor to create a campaign for presenting content to one or more users in a user network responsive to received requests to deliver content. The method further comprises receiving targeting criteria for the campaign including receiving an indication to target one or more inferred groups of users where an inferred group of users is a group of users that share a common characteristic, relationship or interest and where the inferred group of users does not represent a user-defined circle in the user network. The method further comprises storing the campaign. The method further comprises delivering the content to users in the inferred group in accordance with the campaign and responsive to requests for content received from users in the inferred group.

These and other implementations can each optionally include one or more of the following features. The user network can be a social network and where the user-defined circle is a user-defined social circle. Receiving targeting criteria can further comprise receiving separate bids for each of the one or more targeted inferred groups indicated by the content sponsor. The inferred groups can be based on demographic information. Receiving targeting criteria can comprise receiving an indication to target inferred groups, and the method can further comprise identifying, by a processor, one or more appropriate inferred groups to target based on one or more criteria. The targeting criteria can relate to content that is to be displayed along with the content from the content sponsor. The targeting criteria can be specified by the content sponsor. The method can further comprise presenting a control for discovery of one or more inferred groups that can be targeted, and receiving targeting criteria for the campaign can comprise receiving a selection of one or more discovered inferred groups.

In general, another innovative aspect of the subject matter described in this specification can be implemented in methods that include a method for targeting content to users. The method comprises identifying a user network including one or more connected users. The method further comprises identifying a clique of users in the user network, where the clique of users includes users that are highly-connected yet are not included in a specific social circle designated by any users in the user network. The method further comprises targeting content to users in the clique.

These and other implementations can each optionally include one or more of the following features. The user network can be a social network and the clique is a subset of users in a social circle in the social network. The clique can represent an intersection of social circles associated with a plurality of users in the user network. The clique can be represented by a graph where each node in the graph is connected to all or nearly all other nodes in the graph.

In general, another innovative aspect of the subject matter described in this specification can be implemented in systems that include a system for providing content. The system comprises an inferred group engine that determines inferred groups of users in a user network. The system further comprises a sponsor interface that allows a content sponsor to target content in a campaign to one or more users that are members of the inferred groups. The system further comprises a content management system that provides content items responsive to received requests. The content management system comprises a request handler enabled to receive a request for content from a user, identify one or more offers, including offers for a given impression of content items in campaigns targeted to users in inferred groups, and provide a content item responsive to the request and the at least one or more offers.

In general, another innovative aspect of the subject matter described in this specification can be implemented in computer program products that include a computer program product tangibly embodied in a computer-readable storage device and comprising instructions. The instructions, when executed by a processor, cause the processor to identify users in a user network, determine an inferred group of users in the user network where the inferred group is not a user-defined circle in the user network, and use the inferred group to either target content to users in the inferred group or promote content associated with a campaign targeted at the inferred group.

In general, another innovative aspect of the subject matter described in this specification can be implemented in computer program products that include a computer program product tangibly embodied in a computer-readable storage device and comprising instructions. The instructions, when executed by a processor, cause the processor to receive an indication from a content sponsor to create a campaign for presenting content to one or more users in a user network responsive to received requests to deliver content, receive targeting criteria for the campaign including receiving an indication to target one or more inferred groups of users where an inferred group of users is a group of users that share a common characteristic, relationship or interest and where the inferred group of users does not represent a user-defined circle in the user network, store the campaign, and deliver the content to users in the inferred group in accordance with the campaign and responsive to requests for content received from users in the inferred group.

In general, another innovative aspect of the subject matter described in this specification can be implemented in computer program products that include a computer program product tangibly embodied in a computer-readable storage device and comprising instructions. The instructions, when executed by a processor, cause the processor to identify a user network including one or more connected users, identify a clique of users in the user network, where the clique of users includes users that are highly-connected yet are not included in a specific social circle designated by any users in the user network, target content to users in the clique.

In general, another innovative aspect of the subject matter described in this specification can be implemented in methods that include a method, executing on one or more computing devices, for targeting or promoting content. The method comprises identifying users in a user network. The method further comprises determining, using the one or more computing devices, an inferred group of users in the user network where the inferred group is not a user-defined circle in the user network. The method further comprises using the inferred group to either target content to users in the inferred group or promote content associated with a campaign targeted at the inferred group.

Particular implementations may realize none, one or more of the following advantages. Content sponsors may be willing to bid higher for impressions of their content if the content sponsors have control over the types of users who are targeted, including users who are targeted using information related to inferred groups or cliques.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2A shows an example system for creating groups.

FIGS. 2B and 2C collectively show an example system for targeting content to groups of users in a user network.

FIG. 3A is a flowchart of an example process for targeting content based on inferred groups.

FIG. 3B is a flowchart of an example process for serving content to users in inferred groups.

FIG. 3C is a flowchart of an example process for a content sponsor to target content to users in cliques.

FIG. 4 is a block diagram of an example computer system that can be used to implement the methods, systems and processes described in this disclosure.

Like reference numbers and designations in the various drawings indicate like elements.

### DETAILED DESCRIPTION

This document describes methods, processes and systems for targeting and delivering content to users in a user network (e.g., a social network) who are members of a group. For example, an inferred group can be determined for users who are well-connected to each other and/or who share common interests. In some implementations, the inferred group is not one of a user's user-defined groups or circles (e.g., friends, family, etc.). When creating a campaign, a content sponsor can specify (e.g., using targeting criteria) to target content (e.g., advertisements) to one or more inferred groups, and thus to the users in those groups. In some implementations, the inferred groups can be of the form of a clique. In some implementations, a clique is a subset of individuals in which every person is connected to every other person. In some implementations, the connections can be through a network, such as a connection in a social network, or by way of sharing a common interest or trait. Example cliques include cliques of 18- to 24-year-olds, cliques of middle-aged men, cliques of working young women, etc., each of which may be of interest to content sponsors for targeting purposes. As a result, when one of the users receives targeted content, it can include content that is served because the user is a member of a particular inferred group or clique. While cliques are used as an example of inferred groups, the methods, processes and systems described in this document can apply to any other groups of users, inferred or otherwise.

Inferred groups can be determined in various ways. For example, intersections of two or more users' groups or circles (e.g., social groups or social circles) can be formed where all the users (or virtually all of the users) communicate with each other. The determination of inferred groups can further be based on the subject matter of communications among the users. For example, a “yoga” inferred group can be formed among users in a user network (e.g., a social network) who have communicated extensively about yoga such as through postings, email or other communications in the user network. Demographic information (e.g., age, gender, etc.) can also be used in determining inferred groups. For example, another “yoga” inferred group can be an “under-40, female yoga” inferred group that is formed because several women under 40 who are connected in a network have discussed yoga with each other on a networking site.

In some implementations, inferred groups can be determined from a social graph, which is composed of one or more edges connecting the users (e.g., users are represented as nodes in the graph). In such a social graph, a clique can be a subset or a sub-group of users who have edges connecting each other. In some implementations, two users can be connected to each other if they are part of each other's circles or if they have mutually agreed to form a social network connection. Users can be connected in other ways. In some implementations, determining a sub-group of users in the social graph can depend on the number of communications between the users and/or the subject matter of the communications.

In some implementations, inferred groups can be determined independently of a user's circles. For example, an inferred group can be formed for a set of users who actively engage in conversation around a particular topic on a social networking site, even if the users are not friends or followers of each other. An example is an inferred group that includes users from the entire United States who have discussed a new video game that is about to be released to the public. Other inferred groups can rely greatly on a user's circles, such as if a user repeatedly shares many technical articles with users in a particular circle.

Inferred groups can be characterized in different ways. For example, the characteristics of an inferred group can be based on explicit information that can include information specified by users on their social network profile (e.g., age, gender, etc.). In another example, the characteristics of an inferred group can be based on implicit information, including information about an inferred group of users that is learned or inferred based on user behavior (e.g., posts or other communications by fans of action movies).

Content sponsors, for example, can target content to users based on inferred groups. For example, a content sponsor C can submit offers (e.g., bids for use in an auction or an offer that is part of a reservation, hereinafter collectively referred to as an “offer”) for subsequent impressions of content items (e.g., advertisements) in a campaign to users in selected inferred groups G. The offers can depend, for example, on whether users to whom the content is to be presented are members of the selected inferred groups G. Consequently, when content is requested for a particular user (e.g., to fill an advertisement slot on a web page), the user's inferred groups can be looked up or determined, and corresponding offers for content can be identified (e.g., from offers made by the content sponsor C and other content sponsors). For example, if the user is a member of selected inferred groups G associated with the offer, then the bid for the content item can be identified. Depending on the terms of the offer, the content item associated with the content sponsor C can be provided in response to the request for content.

In one example scenario in which targeting to inferred groups can be used, consider an advertiser who has a social product such as a social game, a social app, or some other product that users in a user network (e.g., a social network) may use and/or discuss (e.g., in posts, email or other communications). Because of the social nature of the product, the advertiser would like the product to be adopted by a set of users who may be more likely to engage with each other, i.e., users who are connected to each other or otherwise related in a social sense. The advertiser can want this because a social product can be more successful if it is used by N friends rather than by N strangers. By targeting content to users in cliques or inferred groups who, for example, have discussed the subject matter of the product, advertisers (e.g., content sponsors) may be able to achieve better results (e.g., a higher conversion rate).

In some implementations, users may not be grouped together unless they opt in to policies that group users based, for example, on inferred groups. In some implementations, users can opt out of being targeted for content, including advertisements, based on any inferred groups to which they belong.

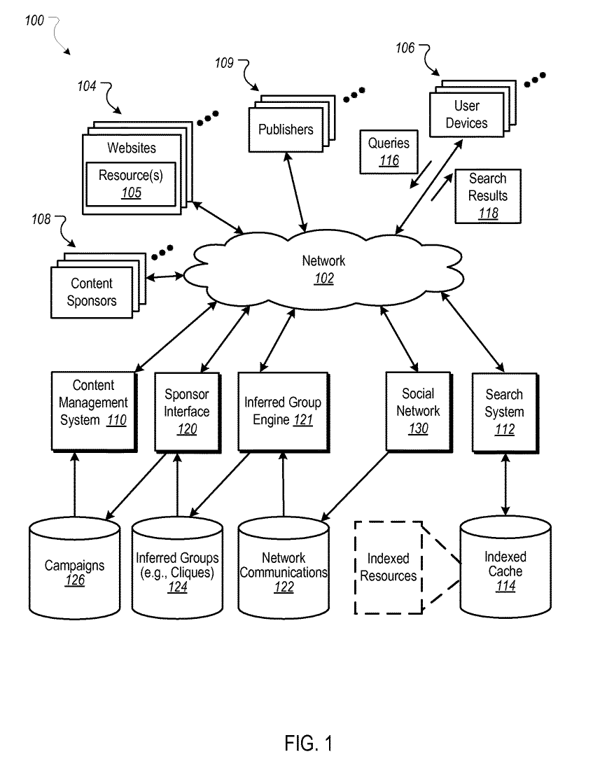

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), content publishers 109, and the content management system 110. The example environment 100 may include many thousands of websites 104, user devices 106, content sponsors 108 and content publishers 109.

The example environment 100 further includes at least one user network, e.g. social network 130, an inferred group engine 121 for associating groups of users in the social network 130 with one or more inferred groups, and a sponsor interface 120 that the content sponsor 108 can use to create campaigns for content items, including to target content items to users who are associated with inferred groups selected for targeting by the content sponsor 108.

In some implementations, the environment 100 can include plural data stores that are used in various stages to create the inferred groups. For example, network communications 122 can store information (e.g., in an anonymized way) about each user's interactions and communications within the social network 130. The information can include, for example, information regarding the times and frequencies that users have communicated with other users and the subject matter of those communications.

A data store of inferred groups 124, for example, can include information about each inferred group. The information can include, for example, lists of users who are in the inferred group. Other information stored for each inferred group can include the number of members in the inferred group, the criteria used to determine the inferred group, demographic information associated with users in the inferred group, and the type of inferred group (e.g., whether the inferred group is based on subject matter, intersections of users' circles, a frequency of communications, or some combination).

A data store of campaigns 126 can store campaigns that are created by content sponsors 108, e.g., using the sponsor interface 120. For example, the campaigns 126 can include targeting criteria specified by content sponsors 108 to target content to users in inferred groups.

In some implementations, the inferred group engine 121 can update the inferred groups 124 over time, for example, as changes occur in the network communications 122 or for other reasons. For example, the inferred group engine 121 can be invoked on a scheduled basis or as needed to keep the information for the inferred groups 124 up-to-date.

In some implementations, the content management system 110 includes a request handler that can receive a request for content from a user, identify one or more eligible content items, and provide a content item responsive to the request. More specifically, the request handler can determine, for campaigns 126 that include targeting criteria defined to target to users in inferred groups, if the user who provided the request for content is a member of one of the inferred groups selected by the content sponsor 108. In some implementations, the request handler can access the inferred groups 124 to determine the inferred groups to which a user belongs.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript scripts).

A user device 106 is an electronic device that is under control of a user and is capable of requesting and receiving resources over the network 102. Example user devices 106 include personal computers, mobile communication devices (e.g., smartphones), and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or web page, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. In some implementations, the content management system 110 can generate search results 118 using information (e.g., identified resources) received from the search system 112. An example search result 118 can include a web page title, a snippet of text or a portion of an image extracted from the web page, and the URL of the web page. Search results pages can also include one or more slots in which other content items (e.g., ads) can be presented. In some implementations, slots on search results pages or other web pages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation) and information related to inferred groups. Information related to inferred groups can include, but is not limited to, whether a content item has been displayed to other members of the inferred group, a response of other members of the inferred group to the content item, and the history of responses of members of the inferred group to content items similar to, for example, one that is being considered for selection. For example, the content item can be an advertisement that appears while the users are visiting or otherwise interacting with a social network site.

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations). The offers represent the amounts that the content sponsors are willing to pay for presentation (or selection) of their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, performance with respect to the inferred group, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a web page, and consummates a purchase there before leaving that web page. A conversion can also be defined by a content provider to be any measurable/observable user action, such as downloading a white paper, navigating to at least a given depth of a website, viewing at least a certain number of web pages, spending at least a predetermined amount of time on a web site or web page, registering on a website, experiencing media, or performing a social action regarding a content item (e.g., an ad), such as republishing or sharing the content item. Other actions that constitute a conversion can also be used.

In some implementations, the likelihood that a conversion will occur can be improved, such as by serving content that is more likely to be of interest to the user. For example, content items (e.g., ads) that are served can be selected in part based on inferred groups to which the user belongs, which can also be an indication of how likely the user is to react positively to a content item, e.g., leading to a conversion. The inferred groups to which a user belongs can also be an indication of a likelihood that the user will discuss or share the content with other users within the inferred groups.

For situations in which the systems discussed here collect personal information about users, the users may be provided with an opportunity to opt in/out of programs or features that may collect personal information (e.g., information about a user's social network, social actions or activities, a user's preferences, or a user's current location). In addition, certain data may be anonymized in one or more ways before it is stored or used, so that personally identifiable information is removed. For example, a user's identity may be anonymized so that the no personally identifiable information can be determined for the user, or a user's geographic location may be generalized where location information is obtained (such as to a city, ZIP code, or state level), so that a particular location of a user cannot be determined. In some implementations, opt out features related to social networking systems, for example, can allow the user to specify that the user's activity stream content is not to be used in ads, or to anonymize the information in some way. Further, in situations in which information is gathered and stored related to the subject matter of communications among users, the information can be aggregated (e.g., to a keyword level), personal information can be omitted (e.g., not stored), and the information can be associated with users using anonymized user identifiers.

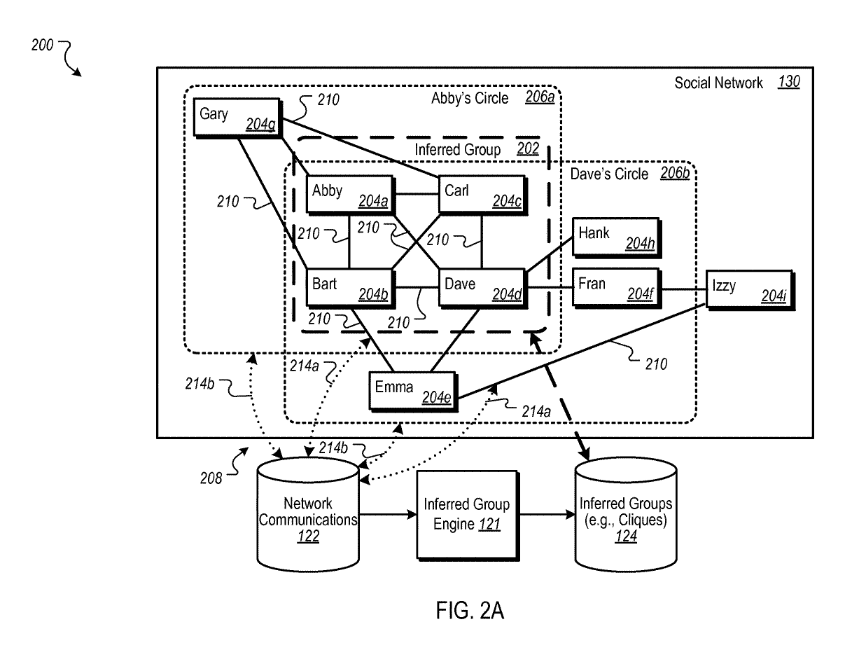

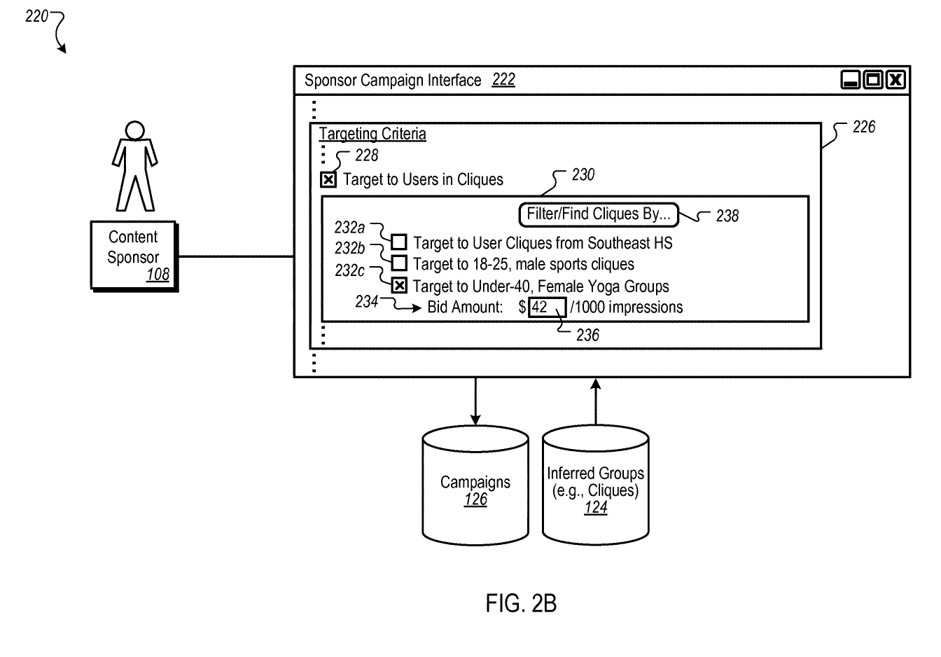

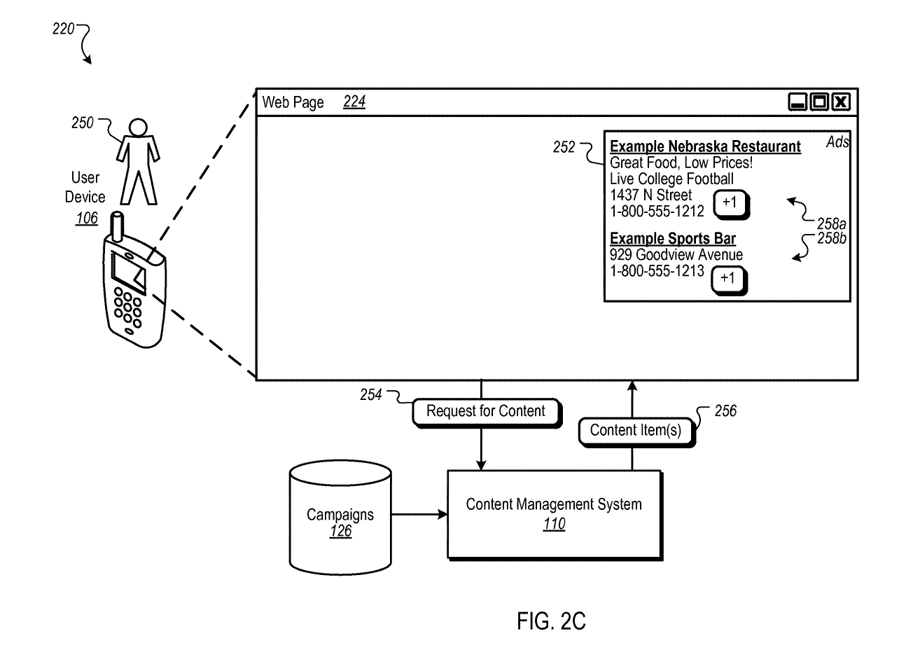

FIG. 2A shows an example system 200 for creating groups. For example, an example inferred group 202 is shown in FIG. 2A that includes users Abby 204a, Bart 204b, Carl 204c and Dave 204d. Users 204a -204i are represented in FIG. 2A as nodes in a graph 208, and relationships (e.g., friendships, communications, etc.) among the users are represented by edges 210 in the graph 208. The set of edges 210 that connect to any one of the users 204a -204i can represent that user's relationships (e.g., friendships, communications, etc.) with other users in a social network 130. While some of the examples that follow are based on intersections of circles of friends, inferred groups can be created that are based on other information, such as frequency of communication among users, the subject matter of each communication, user demographics (e.g., age, gender, etc.), and/or other factors. In the example shown in FIG. 2A, the users Abby 204a through Dave 204d are users in both of Abby's circle of friends 206a and Dave's circle of friend 206b. As a result, the inferred group 202 is an intersection of Abby's circle of friends 206a and Dave's circle of friends 206b. Not included in the inferred group 202 are user Gary 204g (e.g., who is in Abby's circle of friends 206a but not in Dave's circle of friends 206b) and users Emma 204e, Fran 204f and Hank 204h (e.g., who are in Dave's circle of friends 206b but not in Abby's circle of friends 206a).

Dave's circle of friends 206b can be, for example, one of several social circles that user Dave 204d has within the social network 130. For example, user Dave 204d can have separate circles of coworkers and family members in the social network 130 that are not depicted in the graph 208. In some implementations, inferred groups that are created by the inferred group engine 121 can be created based, at least in part, on determining the intersections of one or more circles for each user with all other users in the plurality of users within the social network 130.

In some implementations, the inferred group engine 121 can create inferred groups 124 using information from network communications 122. For example, the inferred group engine 121 can identify the users 204a -204i as users in the same user network. The inferred group engine 121 can determine the inferred group 202, which can include, for example, a group of users in the social network 130 that is not, by itself, a user-defined circle in the user network. Lines 214a indicate an example association between network communications 122 and the edges 210 in the graph 208. Lines 214b indicate an example association between network communications 122 and Abby's circle of friends 206a and Dave's circle of friends 206b.

In some implementations, an inferred group can be a group of users that, among other criteria, are determined to have communicated at least a pre-determined number of times. For example, the inferred group 202 can be the users that are in both of Abby's circle of friends 206a and Dave's circle of friends 206b and who have communicated at least twice, five times or more, or some other pre-determined number of times that can be used by the inferred group engine 121 to determine inferred groups. In some implementations, determining that users are in an inferred group can require, in addition to communication amount, that the user communications have occurred significantly recently (e.g., in the last year, month, etc.) or with sufficient frequency. For example, the users Abby 204a through Dave 204d can be users who have communicated frequently within the last few months.

Demographics can be used to determine inferred groups in some implementations. For example, the creation of inferred groups of users (e.g., by the inferred group engine 121) can include determining users that are members of a same demographic (e.g., age, gender, etc.) who are also in cliques or connected socially in some way. As a result, one example inferred group that can be created is an inferred group that includes users Bart 204b, Carl 204c and Dave 204d, all of whom can be male between the ages of 18 and 24. The inferred group can also include other users not depicted in the graph 208.

In some implementations, inferred groups can be limited to users whose communications with other users are related to a single subject matter. For example, an “environmentalist” inferred group can include members in Dave's circle of friends 206b who are also members of the social circles of the users Hank 204h and Izzy 204i who have discussed global warming. Content sponsors, for example, can use the resulting “environmentalist” inferred group to target content related to environmental concerns (e.g., advertisements for electric cars) to users in the inferred group who may also share the content with other users within their circles (e.g., social circles) of the social network 130.

In some implementations, determining an inferred group can result from determining a sub-group of a social circle for a user and identifying users of the sub-group as belonging to the inferred group. For example, assume that user Abby 204a has more than 1000 friends. The inferred group engine 121 can create an inferred group that can include a sub-group of Abby's friends who are under the age of 40, where the inferred group does not depend on the intersection of Abby's social circles with the social circles of other users. In some implementations, determining a sub-group of users can further comprise identifying the users of the sub-group based on a number of communications between the users. For example, the inferred group of Abby's friends under 40 can be limited to users who have communicated with other users in the group at least a predetermined number of times (e.g., ten times or more). In some implementations, inferred groups based on sub-groups can be further limited based on subject matter of communications between the users. For example, the inferred group of Abby's friends under 40 who have communicated at least a predetermined number of times can be limited to users who have discussed yoga. In another example, an inferred group (e.g., a “tech” group) can be formed if Abby, for example, repeatedly shares many technical articles with the same set of users in one of her particular circles. Any of these example inferred groups can be chosen by content sponsors 108 to target content because members of the inferred groups may be more likely to share or discuss the content with others, including other members in the group.

Combinations of relationships can be used to create inferred groups, e.g., based on relationships described in the previous examples. One example inferred group can be a “yoga” inferred group that includes female members, under age 40, who are members of Abby's, Emma's and Fran's social circles, and who have discussed the subject of yoga in the last three months. Another example includes an inferred group of users who have frequently discussed two subject matters: global warming and coffee. In this example, content sponsors can target content (e.g., packages of organic, rainforest-grown, Fair Trade coffee) to users in an inferred group whose membership in the inferred group is based on frequent discussions of subject matter related to the coffee.

Other relationships among users can also exist that are not shown in the graph 208. For example, the graph 208 is just one of many graphs that can represent relationships among users in the social network 130. As a result, any number of inferred groups, such as the inferred group 202, can be created.

FIGS. 2B and 2C collectively show an example system 220 for targeting content to groups of users in a user network. FIG. 2B, for instance, shows an example sponsor campaign interface 222 for specifying targeting criteria in a campaign that is used to target users in inferred groups 124. For example, the content sponsor 108 can use the sponsor campaign interface 222 to create one or more campaigns 126 (e.g., advertising campaigns) for presenting content (e.g., advertisements), including campaigns that are targeted to users in the social network 130 who are also members of inferred groups 124. In some implementations, the sponsor interface 120 can provide the sponsor campaign interface 222 and/or other interfaces and screens for targeting content to users in inferred groups.

FIG. 2C shows an example user interface 224 in which targeted content is provided based on the user's association with inferred groups 124. As will be described in more detail later, the user interface 224 is one example of how the system 220 can provide targeted content to inferred groups of users in a user network (e.g., a social network). For example, advertisements from the content sponsor's advertising campaign (e.g., campaigns 126) can be provided in response to received requests to deliver content to the user interface 224. In some implementations, the inferred groups 124 used by the system 220 can be created by the system 200 described with reference to FIG. 2A.

Referring again to FIG. 2B, in some implementations, the sponsor campaign interface 222 can include a targeting criteria area 226 from which the content sponsor 108 can select targeting parameters for a campaign. The targeting criteria area 226 can be one of multiple targeting areas within the sponsor campaign interface 222. In some implementations, the targeting criteria area 226 can include one or more controls for receiving an indication from the content sponsor 108 to target one or more inferred groups of users. For example, the content sponsor 108 can select a clique-targeting option 228, e.g., by checking a “Target to users in Cliques” checkbox, as an indication to target content to inferred groups. The term “cliques,” for example, can be the term associated with inferred groups and displayed in various sponsor campaign interfaces. In some implementations, selection of the clique-targeting option 228 can result in the presentation of an options area 230. In some implementations, the options area 230 can include individual controls, e.g., checkboxes 232a-232c, for targeting different types of inferred groups. Example types of inferred groups can include female yoga enthusiasts under forty years old, male environmentalists, and sports enthusiasts with ages 18-25. In some implementations, there can exist multiple inferred groups of female yoga enthusiasts under forty years old, including, for example, the “Yoga” inferred group described above that includes users in Abby's, Emma's and Fran's social circles. Other inferred groups that can be included in this group of inferred groups can be created from other users not represented by the graph 208.

The content sponsor 108, for example, can check the checkbox 232c to target inferred groups of users that include under-40, female yoga enthusiasts. Having the checkbox 232c checked, for example, can result in targeting users in the “Yoga” inferred group described above that includes users Abby 204a, Emma 204e and Fran 204f.

In some implementations, when any of the checkboxes 232a -232c are checked, the sponsor campaign interface 222 can allow the content sponsor 108 to provide separate bids for the corresponding inferred groups. For example, when the checkbox 232c is checked, a bid area 234 can be displayed. The content sponsor 108, for example, can enter a bid amount in a bid amount field 236, e.g., to specify a dollar amount (e.g., $42) for 1000 impressions to users who are in inferred groups of users that include under-40, female yoga enthusiasts. Other bid areas and controls can be presented if the content sponsor 108 checks the checkboxes 232a and 232b to target content to users in inferred group of Southeast High School graduates and 18- to 25-year-old male sports fans, respectively. Other inferred groups can appear in the options area 230 and can be selected by the content sponsor 108 for targeting.

In some implementations, the sponsor campaign interface 222 can include a filter control 238 that the content sponsor 108 can use to search for and/or discover inferred groups that can then be targeted. For example, the content sponsor 108, by selecting the filter control 238, can be presented with another interface (now shown in FIG. 2B). Using the interface, for example, the content sponsor 108 can select or enter terms to find inferred groups such as “a clique of users who play the same video game,” “a clique of users who went to the same school,” etc. In some implementations, the inferred groups that appear in the options area 230 and for which controls such as checkboxes 232a -232c appear can be determined automatically based on selections made by the content sponsor 108 on other parts of the sponsor campaign interface 222.

In some implementations, other ways can be used to specify targeting to inferred groups. For example, other checkboxes similar to the checkboxes 232a -232c and other controls can be used for selecting targeting for other types of inferred groups. Other targeting parameters not shown in FIG. 2B can be stored with other information for the campaign in the campaigns 126 for later use in delivering content.

In some implementations, whenever a new inferred group (e.g., the inferred group 202) is created, affected content sponsors 108 can be notified automatically. Notification can be made, for example, to content sponsors 108 whose targeting keywords correspond to the subject matter of particular inferred groups. For example, when one or more “Yoga” inferred groups are created, content sponsors 108 associated with campaigns that use “yoga” as a targeting keyword can be notified.

In some implementations, if the content sponsor 108 selects a particular inferred group (e.g., by checking one of the checkboxes 232a -232c), additional controls can be presented by which the content sponsor 108 can select a sub-group of the inferred group for targeting. For example, after checking the checkbox 232a (to target Southeast High graduates), the content sponsor 108 can provide other inputs to specify that the targeting further applies to males who graduated in 1977 (e.g., based on an age demographic).

In some implementations, the sponsor campaign interface 222 can include additional controls for the content sponsor 108 to define a custom inferred group. For example, the content sponsor 108 can request that a new inferred group be determined from users who have discussed the subject matter X, Y and X on the social network 130. Then, if an indicator indicates that the number of users in the group is sufficient (e.g., greater than 1000 users), then the content sponsor 108 can elect to target the campaign to that custom inferred group. In this way, for example, the content sponsor 108 can reach potential customers with advertising for a new product that the content sponsor 108 believes would be liked by users who have discussed X, Y and Z.

Referring to FIG. 2C, the user interface 224 can be, for example, a social networking web page or some other interface (e.g., a web browser) that a user 250 is running on the user device 106. The user interface 224 can include one or more content item slots 252, e.g., for displaying advertisements on the social networking web page. To fill the content item slots 252, for example, the user interface 224 can provide a request for content 254 to the content management system 110. Upon receipt of the request for content 254, the content management system 110 can provide content items 256 that are responsive to the request, as described above. As an example, the content items 256 that are provided can be selected based on any inferred groups (e.g., inferred group 202) with which the user 250 is associated.

For example, the user 250 can belong to one or more inferred groups, e.g., the inferred group 202. For each request for content 254 that is received, the content management system 110 can access information in the campaigns 126 to identify content items that are responsive to the request. Some campaigns 126, for example, can be defined to target users in inferred groups. For example, if one or more content sponsors selected the checkbox 232b to targeted to users in inferred groups that include 18- to 25-year-old male sports fans, then one or more of those content sponsors' content items can become an eligible content item that can be selected by the content management system 110. For example, advertisements 258a and 258b can be eligible because the user 250 is a member of an inferred group to which the campaign that includes the advertisements is targeted.

In some implementations, the one or more eligible content items 256 can be evaluated by conducting an auction. For example, the auction can include one or more bids associated with the content sponsors 108 that elected to target users who are associated with inferred groups. As a result, the content items 256 that are provided can be based at least in part on the auction and the inferred group information, as well as other information that can typically be used for selecting content items, e.g., including the relevance of content items to keywords, or criteria for selecting content to fulfill, to name a few examples.

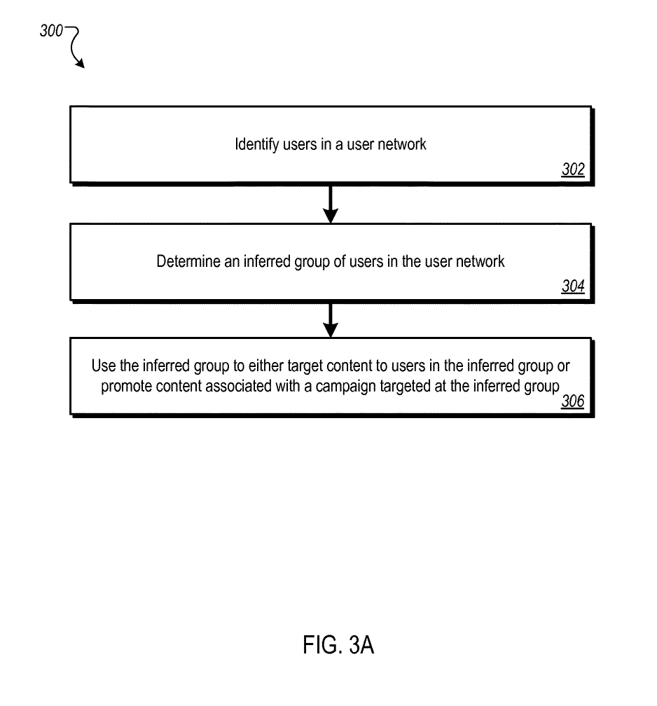

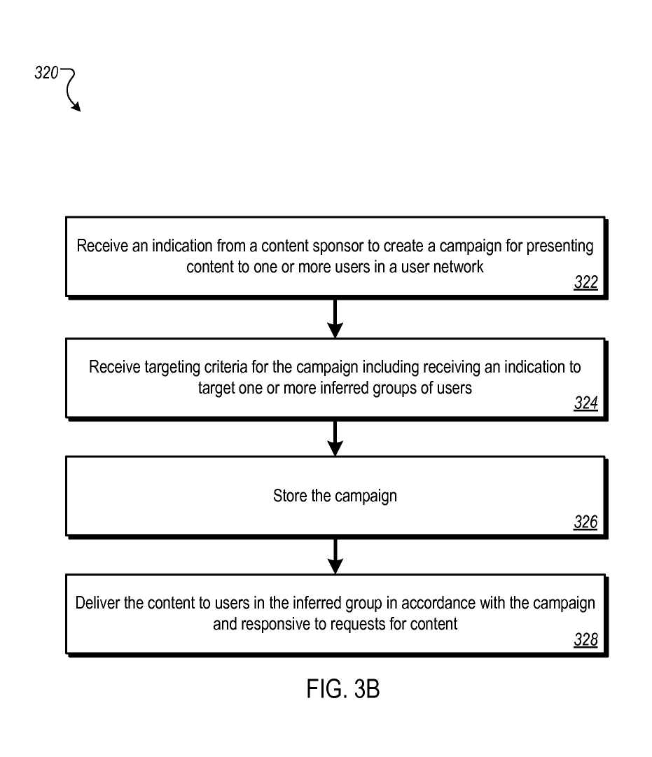

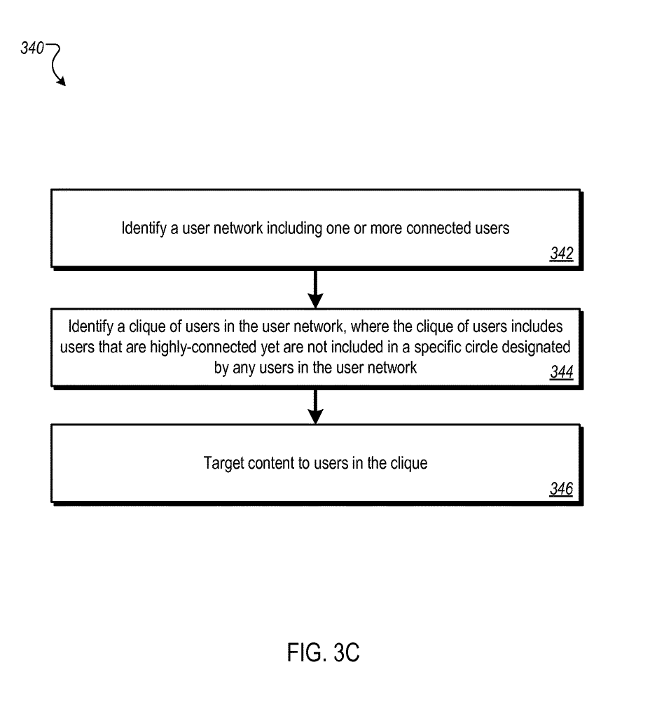

FIG. 3A is a flowchart of an example process 300 for targeting content based on inferred groups. The process 300 can be performed by the content management system 110, for example, using the request handler and the inferred group engine 121. FIGS. 2A-2C are used to provide examples for steps of the process 300.

Users in a user network are identified (302). For example, the inferred group engine 121 can use information from network communications 122 to identify users (e.g., users Abby 204a through Izzy 204i) in the same social network 130.

An inferred group of users in the user network is determined, where the inferred group is not a user-defined circle in the user network (304). For example, the inferred group engine 121 can identify the inferred group 202 based on an intersection of Abby's circle of friends 206a and Dave's circle of friends 206b, which can be, for example, social circles in a social network. Other inferred groups can be determined, such as under-40 female yoga enthusiasts, 18- to 25-year-old male sports fans, groups of users who play the same video game, and users who went to the same high school.

The inferred group is used to either target content to users in the inferred group or promote content associated with a campaign targeted at the inferred group (306). For example, as described above, the content sponsor 108 can use the sponsor campaign interface 222 or other interfaces to target content to users in inferred groups. In another example, content that is promoted by a user can be promoted to users in the inferred group.

In some implementations, targeting can include boosting scores associated with advertisements that are targeted to inferred groups. For example, consider a user (e.g., a sports fan) who is viewing a web page (e.g., in a social networking application) that includes a content item slot for which a request for content occurs to fill the slot. If the user is a member of an inferred group (e.g., related to sports), then the content management system 110 can select an advertisement that is targeted to that inferred group over one or more advertisements that are not targeted to inferred groups. The selection can occur, for example, as a result of boosting a score (e.g., a quality score) of the advertisement that is targeted to sports-related inferred groups. The result of boosting scores in this way can be to favor advertisements that are targeted at an inferred group of users (e.g., over advertisements that are not) which can prove to have a multiplier effect because, for example, of potential subsequent interactions among users in the inferred groups.

Targeting can include enabling content sponsors 108 to bid on impressions of content to users that are in inferred groups. For example, the content item 256 targeted to the user 250 can be selected from advertisements 258a and 258b that have targeting criteria that require that the user be a member of at least one of the inferred groups to which the campaign (e.g., that includes the advertisement) is targeted.

In some implementations, the content item 256 that is provided can be based on conducting an auction. The auction can use the one or more bids associated with the content sponsors, some of which specified to target content to one or more inferred groups. Some bids can include no preference for targeting content to one or more inferred groups and can be evaluated along with the bids of content sponsors that do target content to one or more inferred groups.

FIG. 3B is a flowchart of an example process 320 for serving content to users in inferred groups. The inferred group engine 121, for example, can perform at least some of steps of the process 320. FIG. 2B is used to provide examples for steps of the process 320.

An indication is received from a content sponsor to create a campaign for presenting content to one or more users in a network (322). For example, the content sponsor 108 can select a particular campaign using controls in the sponsor campaign interface 222.

Targeting criteria is received for the campaign including an indication to target one or more inferred groups of users (324). For example, as described above, the content sponsor 108 can make selections in the options area 230 to target the campaign to users in one or more inferred groups. The selections made by the content sponsor 108 can include checking any of the checkboxes 232a -232c and providing any other targeting information.

The campaign is stored (326). For example, based on the selections and inputs provided by the content sponsor 108 on the sponsor campaign interface 222, the campaign (including targeting information for inferred groups) can be stored in the campaigns 126.

The content is delivered to users in the inferred group in accordance with the campaign and responsive to requests for content received from users in the inferred group (328). For example, in response to a request for content 254 that is received to fill one or more content item slots 252 on the user interface 224, the content management system 110 can provide one or more content items 256 that are selected based at least in part on inferred groups with which the user 250 is associated. More specifically, the content items 256 provided, for example, can be from campaigns that target one or more inferred groups to which the user 250 belongs.

FIG. 3C is a flowchart of an example process 340 for a content sponsor to target content to users in cliques. The inferred group engine 121, for example, can perform at least some of steps of the process 320. FIGS. 2A and 2B are used to provide examples for steps of the process 340.

A user network is identified that includes one or more connected users (342). For example, the inferred group engine 121 can identify the social network 130 that includes connected users Abby 204a through Izzy 204i.

A clique of users in the user network is identified, where the clique of users includes users that are highly-connected yet are not included in a specific group or social circle designated by any users in the user network (344). For example, as described above, the inferred group engine 121 can identify the inferred group 202 using information from network communications 122.

Content is targeted to users in the clique (346). For example, the content sponsor can use the sponsor campaign interface 222 to target content to users in one or more inferred groups, as described above.

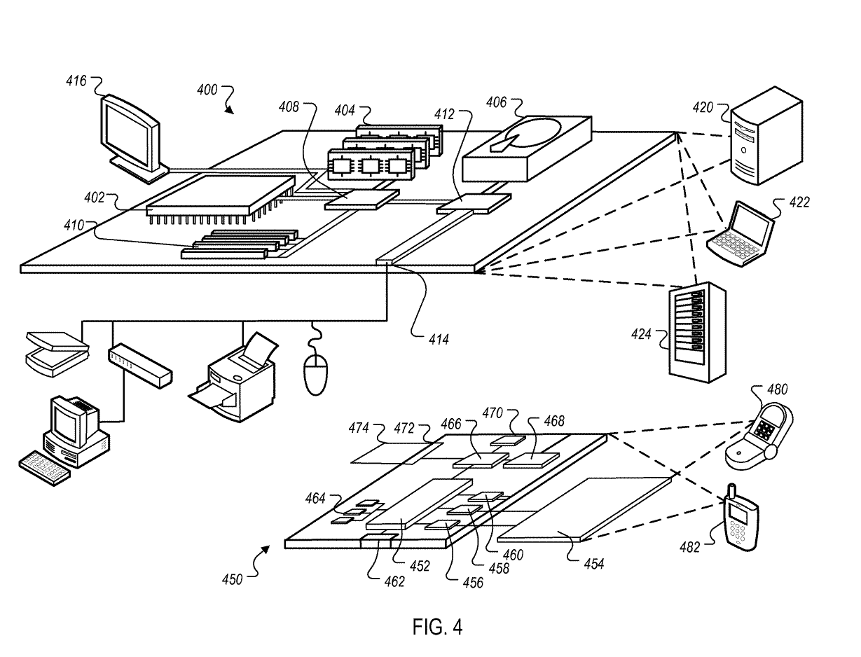

FIG. 4 is a block diagram of computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. Computing device 450 is further intended to represent various typically non-mobile devices, such as televisions or other electronic devices with one or more processers embedded therein or attached thereto. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth™, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication (e.g., via a docking procedure) or for wireless communication (e.g., via Bluetooth™ or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a subscriber identification module (SIM) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth™, Wi-Fi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for providing advertisements, the method comprising:
traversing, by one or more computing devices, nodes and edges of an electronic social graph of a computer-implemented social network to identify user interaction data from a user network, wherein the user network comprises the computer-implemented social network providing information about each user's online user interactions and network communications within the computer-implemented social network and computer-identified relationships with other users in the computer-implemented social network, wherein a node in the electronic social graph represents a user who is a member of the computer-implemented social network, and wherein an interaction between two users is represented in the electronic social graph by an edge between nodes representing respective ones of the two users;
storing the user interaction data in a data store of network communications;
determining, by the one or more computing devices and at least in part based on analysis of the user interaction data from the data store of network communications and for a plurality of users in the user network, two or more groups of users that interact together, wherein each group of users that interact together includes two or more users from the plurality of users in the user network;
identifying a first group of users that interact together from the two or more groups of users, the first group of users forming a first network for a first user, the first network being a subset of the user network;
identifying a second different group of users that interact together from the two or more groups of users, the second different group of users forming a second different network for a second different user, the second different network being a subset of the user network;
based on traversing the electronic social graph, dynamically determining an inferred group of users that share a common interest, with the determining based at least in part on identifying a user in the first group of users who interacts with one or more other users in the first group and who also interacts with one or more users in the second different group of users that interact together from the two or more groups of users;
providing information associated with the inferred group to a content sponsor;
receiving, from the content sponsor, campaign selection criteria for selecting content items in a first campaign, the campaign selection criteria for selecting content based, at least in part, on a potential recipient of the content items being in one or more inferred groups of users including the inferred group, wherein a given inferred group of users is a group of users that share a common characteristic, relationship or interest, and wherein the given inferred group of users does not represent a user-defined circle in the user network;
storing the first campaign;
receiving, by the one or more computing devices, a request to present an advertisement to a user;
determining that the user is in the inferred group;
identifying, from among eligible content items, one or more campaigns for which content sponsors have provided content selection criteria associated with specific inferred groups, the one or more campaigns including the first campaign;
selecting a first content item in the first campaign based on information associated with the received request and the inferred group matching the given inferred group; and
providing the first advertisement.

2. (canceled)

3. The method of claim 1 wherein the group of users that interact together is a user-defined social circle.

4. The method of claim 1 wherein determining the inferred group of users comprises determining users that have communicated at least a pre-determined number of times.

5. The method of claim 1 wherein determining the inferred group of users comprises determining users that are members of the same demographic and including the users in the inferred group.

6. The method of claim 1 further comprising identifying characteristics of users in each group of the two or more groups, attributing the characteristics to members of the inferred group and selecting content for presentation to members of the inferred group based at least in part on the characteristics associated with members of the inferred group.

7. The method of claim 4 wherein communications between group members in the inferred group relate to a single subject matter.

8. The method of claim 1 wherein determining an inferred group further comprises identifying, for each user in a plurality of users, one or more social circles, and determining an intersection of the one or more social circles for each user with all other users in the plurality of users to determine users to be included in the inferred group.

9. The method of claim 1 wherein determining an inferred group further comprises determining a sub-group of a social circle for a user and identifying users of the sub-group as belonging to the inferred group.

10. The method of claim 9 wherein determining a sub-group of users further comprises identifying the users of the sub-group based on a number of communications between the users.

11. The method of claim 9 wherein determining a sub-group of users further comprises identifying the users of the sub-group based on subject matter of communications between the users.

12. The method of claim 1 wherein determining an inferred group further comprises determining a sub-group of users within a social graph, wherein the social graph contains an edge between two users if the two users have mutually agreed to be connected with each other.

13. The method of claim 12 wherein determining a sub-group of users further comprises identifying the users of the sub-group based on a number of communications between the users.

14. The method of claim 12 wherein determining a sub-group of users further comprises identifying the users of the sub-group based on a subject matter of communications between the users.

15. The method of claim 1 further comprising enabling a content sponsor to specify the inferred group as a selection criteria associated with an advertising campaign.

16. The method of claim 1 further comprising enabling one or more content sponsors to discover the inferred group and enabling the one or more content sponsors to specify the inferred group as a selection criteria associated with an advertising campaign.

17. The method of claim 1 wherein providing comprises selecting content to be presented to users of the inferred group upon receipt of a request for content from one of the users.

18. The method of claim 1 wherein providing content further comprises providing content to one or more types of inferred groups including bidding on one or more inferred groups of a given type.

19. The method of claim 18 wherein the one or more types of inferred groups are inferred groups that are specified by a content sponsor for a campaign.

20.-27. (canceled)

28. A computer-implemented method comprising:
traversing, by one or more computing devices, nodes and edges of an electronic social graph of a computer-implemented social network to identify user interaction data from a user network, wherein the user network comprises the computer-implemented social network providing information about each user's online user interactions and network communications within the computer-implemented social network and computer-identified relationships with other users in the computer-implemented social network, wherein a node in the electronic social graph represents a user who is a member of the computer-implemented social network, and wherein an interaction between two users is represented in the electronic social graph by an edge between nodes representing respective ones of the two users;
storing the user interaction data in a data store of network communications;
identifying, by the one or more computing devices, one or more connected users in the user network;
identifying a clique of users in the user network, wherein the clique of users includes users that are highly-connected yet are not included in a specific social circle designated by any users in the user network, the identifying including:
identifying two or more groups of users in the user network;
identifying a first group of users that interact together from the two or more groups of users, the first group of users forming a first network for a first user, the first network being a subset of the user network;
identifying a second different group of users that interact together from the two or more groups of users, the second different group of users forming a second different network for a second different user, the second different network being a subset of the user network; and
based on traversing the electronic social graph, dynamically determining an inferred group of users in the user network that share a common interest, wherein the inferred group is not a user-defined circle in the user network, the determining based at least in part on identifying a user in the first group of users who interacts with one or more other users in the first group and who also interacts with one or more users in the second different group of users that interact together from the two or more groups of users; and
presenting content to users in the clique, including:
receiving, by the one or more computing devices, a request to present an advertisement to a user;
determining that the user is in the inferred group;
identifying, from among eligible content items, one or more campaigns for which content sponsors have provided content selection criteria associated with specific inferred groups, the one or more campaigns including the first campaign;
selecting a first content item in the first campaign based on information associated with the received request and the inferred group matching the given inferred group; and
providing the first advertisement.

29. The method of claim 28 wherein the clique is a subset of users in a social circle in the social network.

30. The method of claim 28 wherein the clique represents an intersection of social circles associated with a plurality of users in the user network.

31. The method of claim 28 wherein the clique is represented by a graph and wherein each node in the graph is connected to all or nearly all other nodes in the graph.

32. A system that provides content items, the system comprising:
an inferred group engine that determines inferred groups of users in a user network, wherein the user network comprises a computer-implemented social network providing information about each user's online user interactions and network communications within the computer-implemented social network and computer-identified relationships with other users in the computer-implemented social network, and wherein determining an inferred group includes:
traversing, nodes and edges of an electronic social graph of the computer-implemented social network to identify identifying user interaction data from a user network, wherein the user network comprises the computer-implemented social network providing information about each user's online user interactions and network communications within the computer-implemented social network and computer-identified relationships with other users in the computer-implemented social network, wherein a node in the electronic social graph represents a user who is a member of the computer-implemented social network, and wherein an interaction between two users is represented in the electronic social graph by an edge between nodes representing respective ones of the two users;
storing the user interaction data in a data store of network communications;
identifying, and at least in part based on analysis of the user interaction data from the data store of network communications and for a plurality of users in the user network, two or more groups of users in the user network;
identifying a first group of users that interact together from the two or more groups of users, the first group of users forming a first network for a first user, the first network being a subset of the user network;
identifying a second different group of users that interact together from the two or more groups of users, the second different group of users forming a second different network for a second different user, the second different network being a subset of the user network;
based on traversing the electronic social graph, dynamically determining an inferred group of users in the user network that share a common interest, wherein the inferred group is not a user-defined circle in the user network, the determining based at least in part on identifying a user in the first group of users who interacts with one or more other users in the first group and who also interacts with one or more users in the second different group of users that interact together from the two or more groups of users; and
providing information associated with the inferred group to a content sponsor;
a sponsor interface that allows a content sponsor to specify presentation criteria for presenting content in a campaign to one or more users that are members of the inferred groups, the campaign selection criteria for selecting content based, at least in part, on a potential recipient of the content items being in one or more inferred groups of users including the inferred group, wherein a given inferred group of users is a group of users that share a common characteristic, relationship or interest, wherein the given inferred group of users does not represent a user-defined circle in the user network; and wherein the campaign is stored; and
a content management system that provides content items responsive to received requests, the content management system comprising a request handler enabled to:
receive a request for content from a user;
identify one or more offers, including offers for a given impression of content items in campaigns defined to present content to users in inferred groups, the one or more campaigns including the first campaign;
determine that the user is in the inferred group; and
provide a content item responsive to the request and the at least one or more offers.

33. A non-transitory computer program product tangibly embodied in a computer-readable storage device and comprising instructions that, when executed by a processor, cause the processor to:
traverse nodes and edges of an electronic social graph of a computer-implemented social network to identify user interaction data from a user network, wherein the user network comprises the computer-implemented social network providing information about each user's online user interactions and network communications within the computer-implemented social network and computer-identified relationships with other users in the computer-implemented social network, wherein a node in the electronic social graph represents a user who is a member of the computer-implemented social network, and wherein an interaction between two users is represented in the electronic social graph by an edge between nodes representing respective ones of the two users;
store the user interaction data in a data store of network communications;
identify users in a user network;
determine an inferred group of users in the user network, wherein the inferred group is not a user-defined circle in the user network, wherein determining the inferred group includes:
identifying two or more groups of users in the user network;
identifying a first group of users that interact together from the two or more groups of users, the first group of users forming a first network for a first user, the first network being a subset of the user network; and
based on traversing the electronic social graph, dynamically identifying a second different group of users that share a common interest and that interact together from the two or more groups of users, the second different group of users forming a second different network for a second different user, the second different network being a subset of the user network;
wherein determining the inferred group of users in the user network is based at least in part on identifying a user in the first group of users who interacts with one or more other users in the first group and who also interacts with one or more users in the second different group of users that interact together from the two or more groups of users; and
use the inferred group to either present content to users in the inferred group or promote content associated with a campaign defined to present content to users in the inferred group, including:
receiving a request to present an advertisement to a user;
determining that the user is in the inferred group;
identifying, from among eligible content items, one or more campaigns for which content sponsors have provided content selection criteria associated with specific inferred groups, the one or more campaigns including the first campaign;
selecting a first content item in the first campaign based on information associated with the received request and the inferred group matching the given inferred group; and
providing the first advertisement.

34. (canceled)

35. A non-transitory computer program product tangibly embodied in a computer-readable storage device and comprising instructions that, when executed by a processor, cause the processor to:
traverse nodes and edges of an electronic social graph of a computer-implemented social network to identify user interaction data from a user network, wherein the user network comprises the computer-implemented social network providing information about each user's online user interactions and network communications within the computer-implemented social network and computer-identified relationships with other users in the computer-implemented social network, wherein a node in the electronic social graph represents a user who is a member of the computer-implemented social network, and wherein an interaction between two users is represented in the electronic social graph by an edge between nodes representing respective ones of the two users;
store the user interaction data in a data store of network communications;
identify one or more connected users in the user network;
identify an inferred clique of users in the user network, wherein the inferred clique of users includes users that are highly-connected yet are not included in a specific social circle designated by any users in the user network, wherein identifying the inferred clique includes:
identifying two or more groups of users in the user network;
identifying a first group of users that interact together from the two or more groups of users, the first group of users forming a first network for a first user, the first network being a subset of the user network;
identifying a second different group of users that interact together from the two or more groups of users, the second different group of users forming a second different network for a second different user, the second different network being a subset of the user network; and
based on traversing the electronic social graph, dynamically determining an inferred group of users in the user network that share a common interest, wherein the inferred group is not a user-defined circle in the user network, the determining based at least in part on identifying a user in the first group of users who interacts with one or more other users in the first group and who also interacts with one or more users in the second different group of users that interact together from the two or more groups of users and;
present content to users in the inferred clique, including:
receiving a request to present an advertisement to a user;
determining that the user is in the inferred group;
identifying, from among eligible content items, one or more campaigns for which content sponsors have provided content selection criteria associated with specific inferred groups, the one or more campaigns including the first campaign;
selecting a first content item in the first campaign based on information associated with the received request and the inferred group matching the given inferred group; and
providing the first advertisement.

36. A method executing on one or more computing devices, the method comprising:
traversing, by one or more computing devices, nodes and edges of an electronic social graph of a computer-implemented social network to identify user interaction data from a user network, wherein the user network comprises the computer-implemented social network providing information about each user's online user interactions and network communications within the computer-implemented social network and computer-identified relationships with other users in the computer-implemented social network, wherein a node in the electronic social graph represents a user who is a member of the computer-implemented social network, and wherein an interaction between two users is represented in the electronic social graph by an edge between nodes representing respective ones of the two users;
storing the user interaction data in a data store of network communications;
identifying, by the one or more computing devices, two or more groups of users in a user network;
identifying a first group of users that interact together from the two or more groups of users, the first group of users forming a first network for a first user, the first network being a subset of the user network;
identifying a second different group of users that interact together from the two or more groups of users, the second different group of users forming a second different network for a second different user, the second different network being a subset of the user network;
based on traversing the electronic social graph, dynamically determining, by the one or more computing devices, an inferred group of users in the user network that share a common interest, wherein the inferred group is not a user-defined circle in the user network, the determining based at least in part on identifying a user in the first group of users who interacts with one or more other users in the first group and who also interacts with one or more users in the second different group of users that interact together from the two or more groups of users; and
using the inferred group to promote content associated with a campaign to the inferred group, the promoting including:
receiving, by the one or more computing devices, a request to present an advertisement to a user;
determining that the user is in the inferred group;
identifying, from among eligible content items, one or more campaigns for which content sponsors have provided content selection criteria associated with specific inferred groups, the one or more campaigns including the first campaign;
selecting a first content item in the first campaign based on information associated with the received request and the inferred group matching the given inferred group; and
providing the first advertisement.
